(19) United States
(12) Patent Application Publication
(10) Pub. No.: US 2022/0019115 A1
(43) Pub. Date: Jan. 20, 2022

(54) LIGHT CONTROL ELEMENT

(71) Applicant: Panasonic Corporation, Osaka (JP)

(72) Inventor: Shotaro Ogawa, Osaka (JP)

(21) Appl. No.: 17/490,977

(22) Filed: Sep. 30, 2021

Related U.S. Application Data
(63) Continuation of application No. PCT/JP2020/009811, filed on Mar. 6, 2020.

(30) Foreign Application Priority Data
Apr. 26, 2019 (JP) 2019-086728

(51) Int. Cl. G02F 1/155

(52) U.S. Cl. CPC G02F 1/155

(57) ABSTRACT

The light control element includes: a plurality of first electrodes having translucency and arranged in parallel to each other, each of the plurality of first electrodes being rectangular and a first electrode; a plurality of second electrodes arranged in parallel to each other and facing the plurality of first electrodes, each of the plurality of second electrodes being rectangular and a second electrode; and an electrolytic solution containing metal and disposed between the plurality of first electrodes and the plurality of second electrodes. The electrolytic solution deposits the metal on any one of the plurality of first electrodes and the plurality of second electrodes in accordance with an applied voltage. At least one of the first electrode and the second electrode has a resistance value higher at the end in a width direction than at a central position in the width direction.

### BACKGROUND

### 1. Technical Field

The present disclosure relates to a light control element.

### 2. Description of the Related Art

Patent Literature (PTL) 1 discloses an electrochromic device in which at least one of a first electrically conductive layer and a second electrically conductive layer includes a patterned layer including an insulating material and a patterned electrically conductive layer including a resistive material, and a resistance value is changed in accordance with a distance from each of bus bars provided at the respective facing ends of the first electrically conductive layer and the second electrically conductive layer. This electrochromic device has a minimum resistance value at a position farthest from each bus bar.
PTL 1 is Unexamined Japanese Patent Publication No. 2015-527614.

### SUMMARY

An object of the present disclosure is to provide a light control element that suppresses an electric field of an edge in a width direction of an electrode at the time of driving an electrochromic (EC) element and reduces display unevenness to achieve high-quality display.

A light control element of the present disclosure includes: a plurality of first electrodes having translucency and arranged in parallel to each other, each of the plurality of first electrodes being rectangular and a first electrode; a plurality of second electrodes arranged in parallel to each other and facing the plurality of first electrodes, each of the plurality of second electrodes being rectangular and a second electrode; and an electrolytic solution containing metal and disposed between the plurality of first electrodes and the plurality of second electrodes. The electrolytic solution deposits the metal on any one of the plurality of first electrodes and the plurality of second electrodes in accordance with an applied voltage. At least one of the first electrode and the second electrode has a resistance value higher at the end in a width direction than at a central position in the width direction.

According to the present disclosure, an electric field of an edge in a width direction of an electrode at the time of driving an electrochromic (EC) element is suppressed, and display unevenness is reduced to achieve high-quality display.

### BRIEF DESCRIPTION OF DRAWINGS

FIG. 1 is a view for explaining a structural example of an EC element according to a first exemplary embodiment.

FIG. 2 is a view illustrating a structural example of a light control device according to the first exemplary embodiment.

FIG. 3 is a view illustrating a cross-sectional line of the EC element.

FIG. 4 is a view for explaining a structural example of the EC element according to the first exemplary embodiment.

FIG. 5 is a view for explaining a structural example of the EC element in a B-B′ cross section indicated in FIG. 3.

FIG. 6 is an electric-field distribution diagram of the EC element in the B-B′ cross section indicated in FIG. 3.

FIG. 7 is a view illustrating an example of an ideal electrode resistance value curve.

FIG. 8 is a graph illustrating an example of a temporal change graph of a potential.

FIG. 9 is a view illustrating an arrangement example of low-resistance electrode members in an A-A cross section indicated in FIG. 3.

FIG. 10 is a view illustrating an arrangement example of the low-resistance electrode members.

FIG. 11 is a view for explaining a manufacturing procedure example of an electrode including the low-resistance electrode members and a high-resistance electrode member.

FIG. 12 is a view illustrating an arrangement example of low-resistance electrode members having different sizes.

FIG. 13 is a view illustrating an arrangement pattern example of the low-resistance electrode members in a pixel region.

FIG. 14 is a diagram illustrating an example of the shapes of a first electrode group and a second electrode group.

FIG. 15 is a diagram illustrating an example of the shapes of the first electrode group and the second electrode group.

FIG. 16 is a diagram illustrating an example of the shapes of the first electrode group and the second electrode group.

FIG. 17 is a diagram illustrating an example of an electrode resistance value curve according to the arrangement pattern of the low-resistance electrode members.

FIG. 18 is a diagram illustrating an example of an electrode resistance value curve according to the arrangement pattern of the low-resistance electrode members.

FIG. 19 is a view illustrating an example of the display unevenness of the EC element.

FIG. 20 is a view illustrating a second configuration example of the EC element.

FIG. 21 is a view illustrating an example of the display unevenness of the EC element.

FIG. 22 is a view illustrating a third configuration example of the EC element.

FIG. 23 is a view illustrating an example of deposition of metal of the EC element in the third configuration example.

FIG. 24 is a view illustrating a fourth configuration example of the EC element.

FIG. 25 is a view illustrating the fourth configuration example of the EC element.

FIG. 26 is a view illustrating an example of deposition of metal of the EC element in the fourth configuration example.

### DETAILED DESCRIPTION

### (Circumstances Leading to Contents of First Exemplary Embodiment)

Conventionally, there has been provided an electrochromic device (hereinafter referred to as an EC element) in which at least one of a first electrically conductive layer and a second electrically conductive layer includes a patterned layer including an insulating material and a patterned electrically conductive layer including a resistive material, and a resistance value is changed in accordance with a distance from each of bus bars provided at the respective facing ends of the first electrically conductive layer and the second electrically conductive layer. The EC element has the minimum resistance value at the position farthest from each bus bar, and the display unevenness that occurs on the outer periphery of the EC element can be reduced. However, when passive-matrix driving is performed on the EC element as thus described, a plurality of EC display pixels (hereinafter referred to as display pixels) are provided for a pair of electrodes, and hence there has been a possibility that display unevenness occurs at the edge of each of the plurality of display pixels.

Therefore, in the following first exemplary embodiment, a description will be given of an example of an electrochromic (EC) element that suppresses an electric field of an edge in a width direction of an electrode at the time of performing passive-matrix driving on an EC element and reduces display unevenness to achieve high-quality display.

Hereinafter, each exemplary embodiment specifically disclosing the configuration and action of the EC element as an example of the light control element according to the present disclosure will be described in detail with reference to the drawings as appropriate. However, an unnecessarily detailed description may be omitted. For example, the detailed description of already well-known matters and the overlap description of substantially the same configurations may be omitted. This is to avoid an unnecessarily redundant description below and to facilitate understanding of a person skilled in the art. Note that the attached drawings and the following description are provided for those skilled in the art to fully understand the present disclosure and are not intended to limit the subject matter as described in the appended claims.

### First Exemplary Embodiment

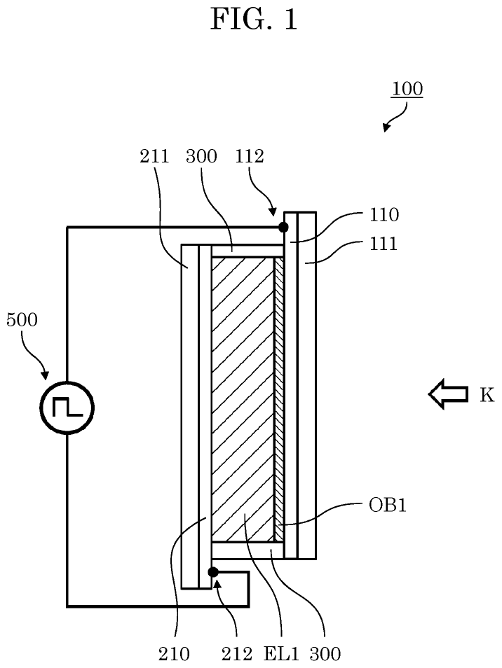

With reference to FIG. 1, a structure of EC (electrochromic) element 100 according to a first exemplary embodiment will be described. An arrow K illustrated in FIG. 1 indicates the direction of the line of sight of a user (e.g., a user of the EC element). Metal OB1 illustrated in FIG. 1 is in a deposited state and forms a metal thin film on the surface of first electrode group 110.

As illustrated in FIG. 1, EC element 100 includes first electrode group 110, first substrate 111, first electrode connector 112, second electrode group 210, second substrate 211, second electrode connector 212, electrolytic solution EL1, and spacer 300 and is driven by EC element drive circuit 500.

First electrode group 110 is a conductive film having translucency and is, for example, a transparent electrode such as indium tin oxide (ITO). Note that first electrode group 110 is not limited to ITO but may be, for example, a transparent electrode (conductive film) made of zinc oxide, tin oxide, or the like.

First substrate 111 is formed using an insulating material such as glass or resin. First substrate 111 is, for example, a rectangular plate body having translucency and is provided on first electrode group 110 so as to face second substrate 211.

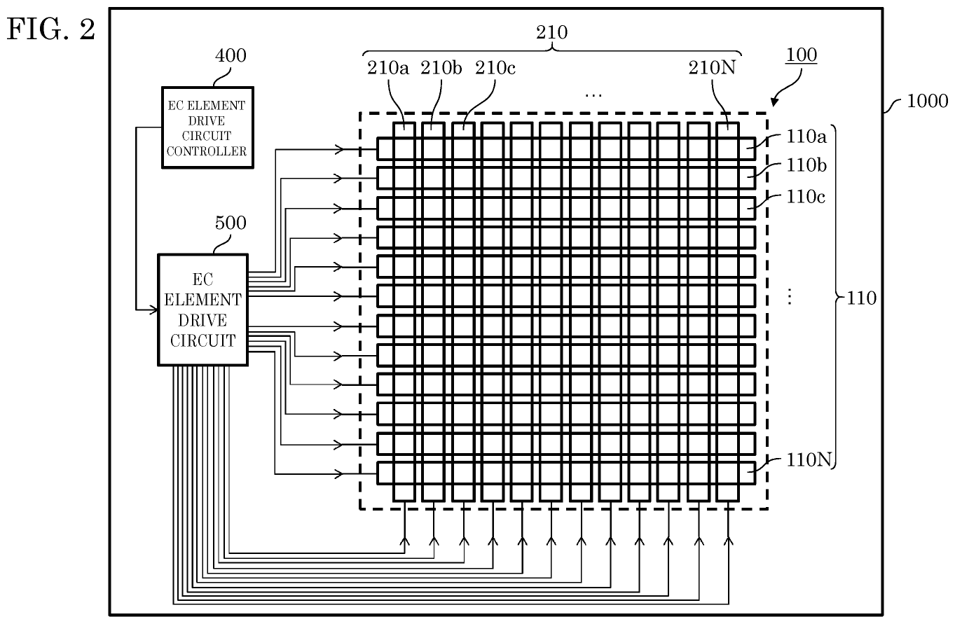

First electrode connector 112 connects first electrode group 110 and EC element drive circuit 500. First electrode connector 112 is not in contact with electrolytic solution EL1 and is connected to an exposed portion between spacer 300 and each of a plurality of first electrodes 110a, 110b, 110c, . . . , 110N (cf. FIG. 2).

Second electrode group 210 is a conductive film having translucency and is, for example, a transparent electrode such as indium tin oxide (ITO). Note that second electrode group 210 is not limited to ITO but may be a transparent conductive film made of, for example, zinc oxide or tin oxide.

Second substrate 211 is formed using an insulating material such as glass or resin. Second substrate 211 is, for example, a rectangular plate body having translucency and is provided on second electrode group 210 so as to face first substrate 111.

Second electrode connector 212 connects second electrode group 210 and EC element drive circuit 500. Second electrode connector 212 is not in contact with electrolytic solution EL1 and is connected to an exposed portion between spacer 300 and each of the plurality of second electrodes 210a, 210b, 210c, . . . , 210N exposed to the outside (cf. FIG. 2).

Electrolytic solution EL1 is provided in a space formed by first electrode group 110, second electrode group 210, and spacer 300. Electrolytic solution EL1 is a solution containing metal OB1 in a metal-ion state and having electrical conductivity. Electrolytic solution EL1 is, for example, a solution containing silver. Metal OB1 contained in electrolytic solution EL1 is deposited on one of first electrode group 110 and second electrode group 210 in accordance with an electric field generated by a voltage applied to first electrode group 110 and second electrode group 210. Deposited Metal OB1 forms a metal thin film on the surface of one of first electrode group 110 and second electrode group 210. The electrode on which metal OB1 is deposited changes in accordance with the polarity of the voltage applied by EC element drive circuit 500 to be described later. In FIG. 1, metal OB1 is deposited on first electrode group 110 to form a metal thin film.

Note that metal OB1 is not limited to the silver described above. Metal OB1 may be, for example, aluminum, platinum, chromium, or other metals including a noble metal such as gold. Metal OB1 functions as a mirror (reflection state) at the time of deposition in a case where metal OB1 is a metal having high reflectance with respect to light, and functions as a light-shielding material (light-shielding state) in a case where metal OB1 is a metal that does not reflect light.

In EC element 100 according to the first exemplary embodiment described above, the user is assumed to see first substrate 111 from the arrow K illustrated in FIG. 1. Thus, second electrode group 210 and second substrate 211 may be opaque. For example, second substrate 211 may be a silicon substrate or the like. Similarly, second electrode group 210 may be a metal electrode such as copper.

Spacer 300 is formed by, for example, annularly applying a resin material such as a thermosetting resin and curing the resin material. Spacer 300 is annularly provided along the peripheral edge of each of first electrode group 110 and second electrode group 210 disposed to face each other. Note that spacer 300 is provided except for an exposed portion where one end of first electrode group 110 can be connected to first electrode connector 112 and one end of second electrode group 210 can be connected to second electrode connector 212.

EC element drive circuit 500 is a power supply unit for applying a voltage to first electrode group 110 and second electrode group 210. EC element drive circuit 500 is connected to each of first electrode connector 112 and second electrode connector 212 via a lead wire and applies a voltage to first electrode group 110 and second electrode group 210. EC element drive circuit 500 controls an electrode on which metal OB1 is deposited in accordance with the polarity of the voltage applied to each of first electrode group 110 and second electrode group 210.

Hereinafter, a method of operating the optical state of EC element 100 will be described. The optical state of EC element 100 includes a transparent state, a reflection state, and a light-shielding state.

First, a description will be given of an operation method when EC element 100 switches the optical state from the transparent state to the reflection state by deposition and dissolution of metal OB1. In the following description, an operation method in which the operation in which metal OB1 is deposited on first electrode group 110 is set to the reflection state or the light-shielding state will be described, but the electrode on which metal OB1 is deposited is not limited.

EC element drive circuit 500 applies a voltage to EC element 100 such that first electrode group 110 has a low potential and second electrode group 210 has a high potential. At this time, the direction of the electric field generated by the applied voltage of EC element drive circuit 500 is a direction from second electrode group 210 to first electrode group 110.

Metal OB1 contained in electrolytic solution EL1 is, for example, a silver ion in a dissolved state. When a voltage is applied to EC element 100, metal OB1 is deposited on the surface of first electrode group 110 (the electrode on the low potential side) to form a metal thin film (e.g., silver thin film). Deposited metal OB1 (e.g., silver thin film) has high reflectance and functions as a mirror (reflection state) when viewed from the direction of the arrow K. When metal OB1 is a metal that hardly reflects light, deposited metal OB1 functions as a light-shielding material (light-shielding state).

EC element drive circuit 500 is controlled by a control signal input from EC element drive circuit controller 400 to be described later. EC element drive circuit 500 switches the optical state of EC element 100 from the transparent state to the reflection state or the light-shielding state on the basis of the input control signal. Furthermore, in a case where the operation is maintained in the reflection state or the light-shielding state, EC element drive circuit 500 continues to apply the voltage.

Next, a description will be given of an operation method when EC element 100 switches the optical state from the reflection state to the transparent state by deposition and dissolution of metal OB1.

EC element drive circuit 500 stops applying the voltage in order to dissolve deposited metal OB1 again. As a result, metal OB1 can return to an ionic state.

In a case where EC element 100 is switched to the transparent state in a shorter time, EC element drive circuit 500 applies a voltage having the opposite polarity. Specifically, EC element drive circuit 500 applies, to EC element 100, a voltage that causes first electrode group 110 to have a high potential and causes second electrode group 210 to have a low potential. Thereby, in EC element drive circuit 500, metal OB1 starts to be deposited on second electrode group 210, and metal OB1 deposited on first electrode group 110 can be dissolved in a shorter time.

When EC element drive circuit 500 has the opposite polarity and applies the same voltage, metal OB1 is deposited on second electrode group 210 to form a metal thin film. Therefore, in a case where the optical state of EC element 100 is set to the transparent state, EC element drive circuit 500 applies, to EC element 100, an applied voltage less than the voltage at which metal OB1 starts to be deposited on second electrode group 210, and shortens the time when metal OB1 is deposited on first electrode group 110 again to form the metal thin film. As a result, EC element drive circuit 500 can switch the optical state of EC element 100 between the transparent state and the reflection state (or the light-shielding state) while maintaining the formation speed of the metal thin film of metal OB1 in first electrode group 110.

Next, a structural example of light control device 1000 according to the first exemplary embodiment will be described with reference to FIG. 2. Light control device 1000 includes EC element 100, EC element drive circuit controller 400, and EC element drive circuit 500. Note that EC element 100 illustrated in FIG. 2 does not illustrate first electrode connector 112, second electrode connector 212, electrolytic solution EL1, and spacer 300 in order to facilitate understanding of the arrangement of each of the plurality of first electrodes 110a, 110b, 110c, . . . , 110N and the arrangement of each of the plurality of second electrodes 210a, 210b, 210c, . . . , 210N.

EC element 100 includes first electrode group 110 made up of the plurality of first electrodes 110a, . . . , 110N, second electrode group 210 made up of a plurality of second electrodes 210a, . . . , 210N, electrolytic solution EL1, and spacer 300. In EC element 100, metal OB1 is deposited at each of a plurality of intersections (hereinafter, display pixels) of first electrode group 110 and second electrode group 210 in accordance with the applied voltage to form a metal thin film.

Each of the plurality of first electrodes 110a, . . . , 110N and each of the plurality of second electrodes 210a, . . . , 210N are arranged orthogonal to each other. Note that the plurality of first electrodes 110a, . . . , 110N and the plurality of second electrodes 210a, . . . , 210N are not limited to the orthogonal arrangement described above but may be arranged at an angle of 120°, for example. In other words, the shape of metal OB1 deposited on each of the plurality of display pixels is not limited to the square shape but may be, for example, a quadrangle such as a rhombus.

EC element drive circuit controller 400 includes a processor (not illustrated) and a memory (not illustrated). The processor is configured using, for example, a central processing unit (CPU), a micro processing unit (MPU), a digital signal processor (DSP), or a field-programmable gate array (FPGA).

A processor (not illustrated) of EC element drive circuit controller 400 performs various types of processing and control in cooperation with the memory. Specifically, the processor refers to a program and data held in the memory and executes the program to achieve the function of EC element drive circuit controller 400. For example, the processor outputs, to EC element drive circuit 500, a control signal for controlling a timing of changing a voltage to be applied to each of first electrode group 110 and second electrode group 210 included in EC element 100 by EC element drive circuit 500, a polarity of the applied voltage, a magnitude of the applied voltage, and the like.

The memory (not illustrated) of EC element drive circuit controller 400 includes, for example, a random-access memory (RAM) as a work memory used at the time of processing of EC element drive circuit controller 400, and a read-only memory (ROM) that stores a program and data defining the operation of EC element drive circuit controller 400. Data or information generated or acquired by the processor is temporarily stored in the RAM. In the ROM, a program that defines the operation (e.g., a driving method of EC element 100 executed by EC element drive circuit 500 according to the first exemplary embodiment) of EC element drive circuit controller 400 is written.

EC element drive circuit 500 applies a voltage to each of the plurality of first electrodes 110a, . . . , 110N via first electrode connector 112 and applies a voltage to each of the plurality of second electrodes 210a, . . . , 210N via second electrode connector 212 on the basis of the control signal output from EC element drive circuit controller 400.

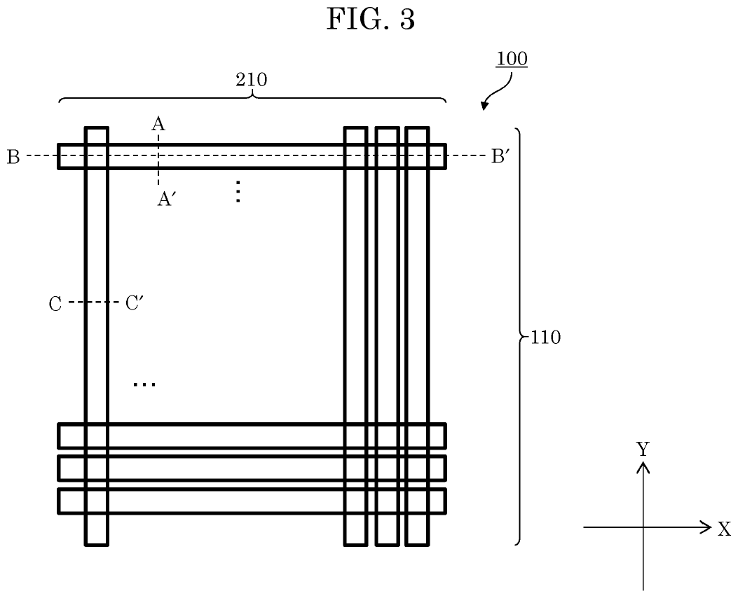

FIG. 3 is a view illustrating a cross-sectional line of EC element 100. The cross-sectional views used in the description of the drawings shown below are cross-sectional views taken along an A-A cross-sectional line, a B-B′ cross-sectional line, and a C-C′ cross-sectional line indicated in FIG. 3, respectively.

The A-A cross-sectional line is a cross-sectional line with the width direction of first electrode 110a as a cut. An A-A′ cross section indicated by the A-A′ cross-sectional line is equal to a cross-sectional view in the width direction of each of the plurality of first electrodes 110a, . . . , 110N constituting first electrode group 110. The B-B′ cross-sectional line is a cross-sectional view of EC element 100 with the longitudinal direction as a cut at the central position in the width direction of first electrode 110a. A B-B′ cross section indicated by the B-B′ cross-sectional line is equal to the longitudinal cross-sectional view at the central position in the width direction of each of the plurality of first electrodes 110a, . . . , 110N constituting first electrode group 110. The C-C′ cross-sectional line is a cross-sectional line with the width direction of second electrode 210a as a cut. A C-C′ cross section indicated by the C-C′ cross-sectional line is equal to a cross-sectional view in the width direction of each of the plurality of second electrodes 210a, . . . , 210N constituting second electrode group 210.

Note that the width direction described above is a direction in which the plurality of first electrodes 110a, . . . , 110N or the plurality of second electrodes 210a, . . . , 210N are arranged in parallel and is a short direction of each of the plurality of first electrodes 110a, . . . , 110N and each of the plurality of second electrodes 210a, . . . , 210N formed in a rectangular shape.

An X direction illustrated in FIG. 3 indicates a longitudinal direction in first electrode group 110 or a width direction in second electrode group 210 of EC element 100. AY direction illustrated in FIG. 3 indicates a width direction in first electrode group 110 or a longitudinal direction in second electrode group 210 of EC element 100.

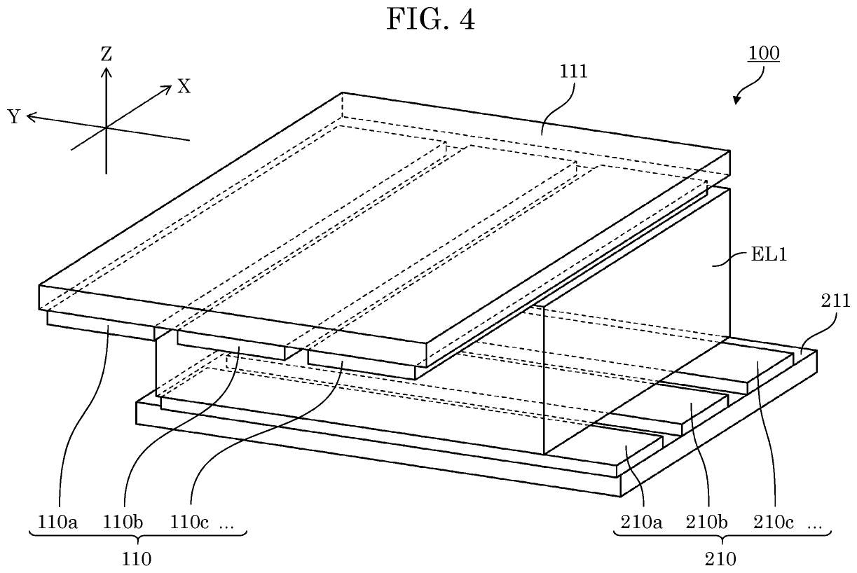

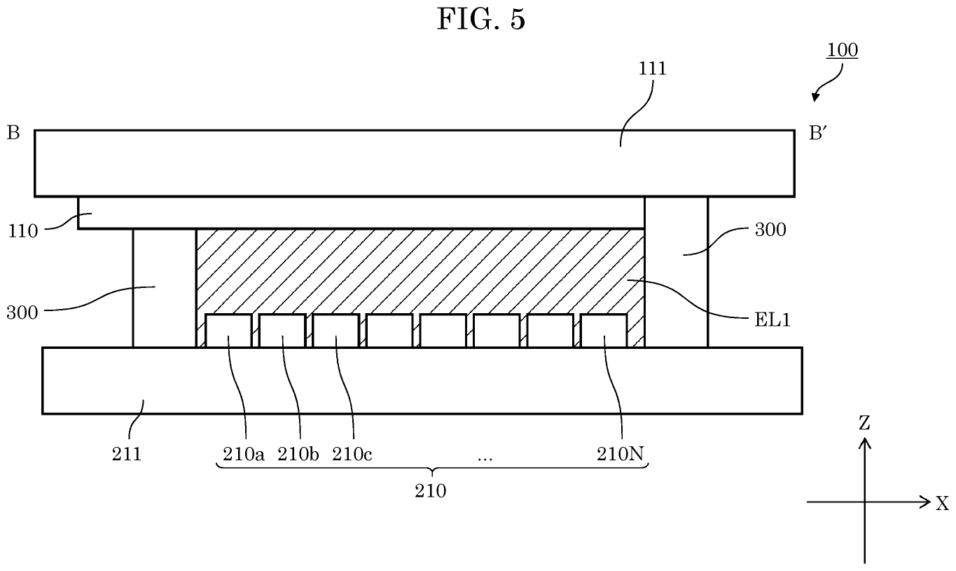

Next, a structural example of EC element 100 will be described with reference to FIGS. 4 and 5. FIG. 4 is a stereoscopic perspective view of EC element 100, and FIG. 5 is a cross-sectional view of EC element 100 in B-B′ cross section.

FIG. 4 is a view illustrating a structural example of EC element 100 according to the first exemplary embodiment. FIG. 5 is a view illustrating a structural example of EC element 100 in the B-B′ cross section. A Z direction illustrated in FIG. 4 indicates a direction in which first electrode group 110 and second electrode group 210 face each other. In FIG. 4, a description will be given using a part of the stereoscopic perspective view of EC element 100 for easy understanding of the description.

The plurality of first electrodes 110a, 110b, 110c, . . . , 110N constituting first electrode group 110 are arranged in parallel in the Y direction with a predetermined gap. First electrode group 110 includes an exposed portion at the end in the −X direction. In first electrode group 110, first electrode connector 112 is connected to the exposed portion, and a voltage is applied by EC element drive circuit 500. In FIGS. 4 and 5, first electrode connector 112 is omitted.

First substrate 111 is integrally provided on the surface of first electrode group 110 opposite to the surface facing second electrode group 210 (hereinafter, Z direction) so as to cover first electrode group 110.

The plurality of second electrodes 210a, 210b, 210c, . . . , 210N constituting second electrode group 210 are arranged in parallel in the X direction to face first electrode group 110 with a predetermined gap. Second electrode group 210 includes an exposed portion at the end in the −Y direction. In second electrode group 210, second electrode connector 212 is connected to the exposed portion, and a voltage is applied by EC element drive circuit 500. In FIGS. 4 and 5, second electrode connector 212 is omitted.

Second substrate 211 is integrally provided on the surface of second electrode group 210 in a direction (hereinafter, −Z direction) opposite to a direction facing first electrode group 110 so as to cover second electrode group 210.

Spacer 300 is annularly provided along the peripheral edges of first electrode group 110 and second electrode group 210 except for the exposed portion provided at one end of first electrode group 110 and the exposed portion provided at one end of second electrode group 210. In FIG. 4, spacer 300 is omitted.

Electrolytic solution EL1 is provided in a space formed by first electrode group 110, second electrode group 210, and spacer 300.

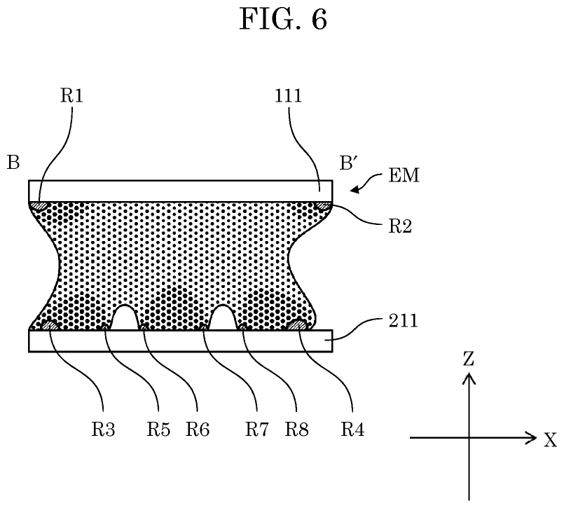

FIG. 6 is an electric-field distribution diagram EM of EC element 100 in the B-B′ cross section. FIG. 6 is a view illustrating an electric field intensity between first substrate 111 and second substrate 211 in the B-B′ cross section when a voltage at which metal OB1 can be deposited is applied. Although a number of the plurality of second electrodes illustrated in FIG. 6 is three, it is needless to say that the number is not limited thereto.

In the electric-field distribution diagram EM illustrated in FIG. 6, each of points R1, R2, R3, R4, R5, R6, R7, R8 indicates a portion where the electric field concentrates.

Each of points R1, R2 indicates an electric field concentrated at each end in the longitudinal direction of first electrode group 110. Points R3, R4 indicate electric fields concentrated at both ends in the width direction of an electrode (e.g., second electrodes 210a, 210N) disposed at both ends of each of the plurality of second electrodes 210a, . . . , 210N and having no adjacent electrode. Each of points R5, R6, R7, R8 indicates an electric field concentrated between the end of each of the plurality of second electrodes 210a, . . . , 210N and the gap. In addition, in the electric field at each of points R5, R6, R7, R8, since the gap between each of the plurality of second electrodes 210a, . . . , 210N and the adjacent second electrode is small, a range where the electric field concentrates is small as compared with the electric field at each of points R3, R4.

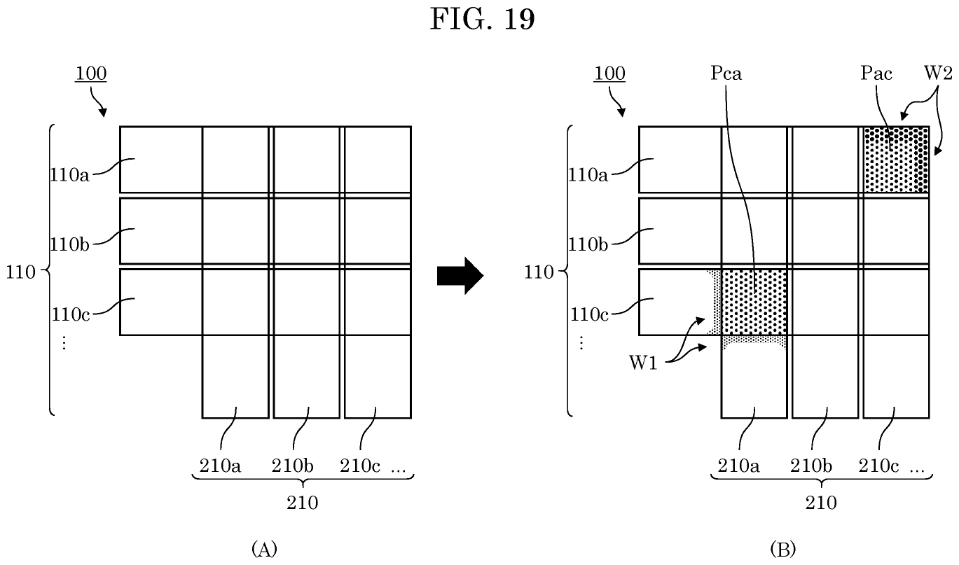

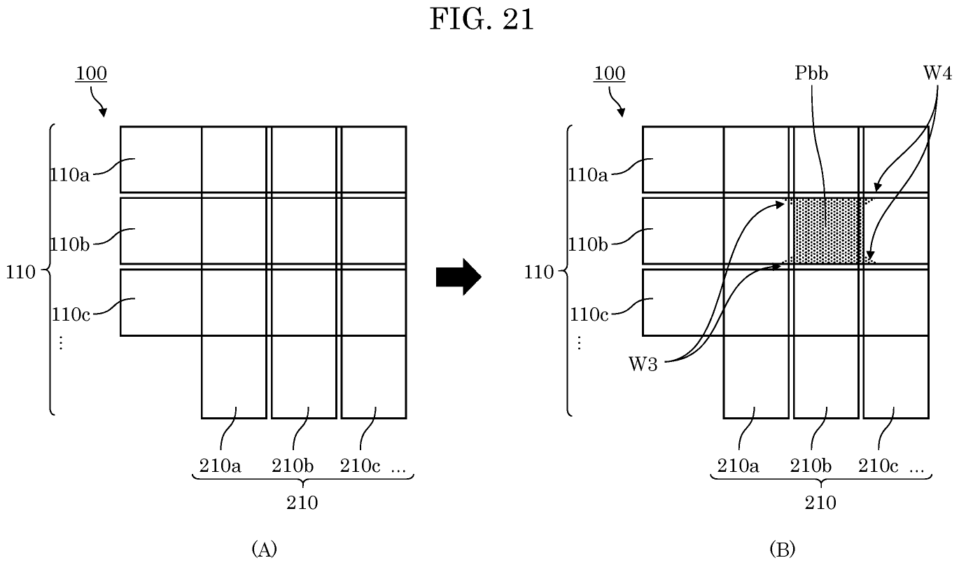

In the portion where the electric field intensity is high illustrated in each of points R1 to R8 described above, metal OB1 is deposited beyond the region where first electrode group 110 and second electrode group 210 intersect as in display pixels Pac, Pca, Pbb illustrated in FIGS. 19 and 21 described later, or metal OB1 is concentrated and deposited in a part of the region, whereby display unevenness occurs. The electric field tends to concentrate in the portion where the electric field intensity is high illustrated at each of points R1 to R8, and hence the time until metal OB1 is deposited is fast. At each of these points R1 to R8, the electric field intensity is high, and more metal OB1 is deposited, so that it takes a lot of time to switch EC element 100 to the transparent state.

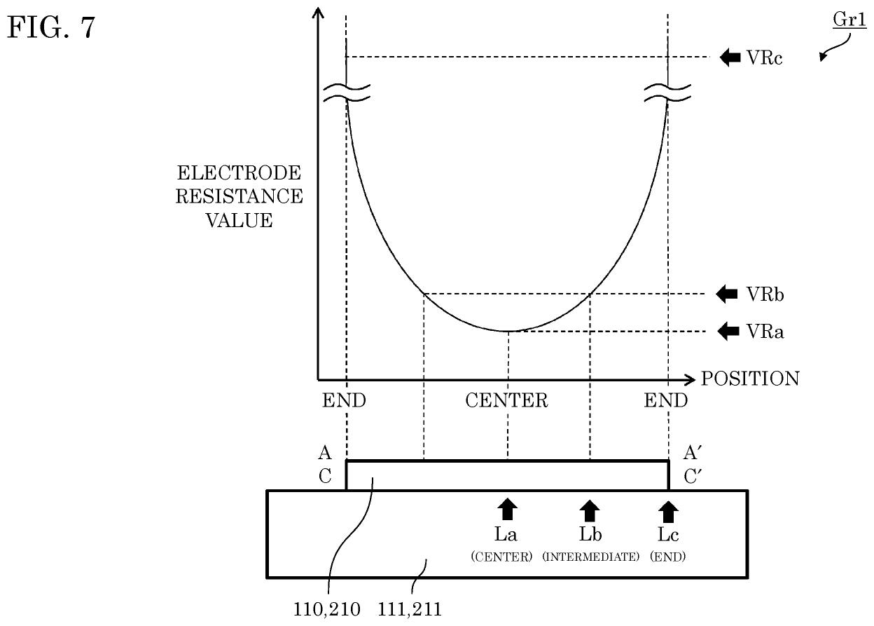

EC element 100 for reducing the electric field intensity illustrated at each of points R1 to R8 will be described with reference to FIGS. 7 to 26.

### First Configuration Example

A first configuration example of EC element 100 according to the first exemplary embodiment will be described. In the first configuration example, each of the plurality of first electrodes 110a, . . . , 110N and each of the plurality of second electrodes 210a, . . . , 210N constituting EC element 100 are formed so as to have different electrode resistance values in accordance with positions in the width direction. The first configuration example will be described with reference to FIGS. 7 to 18. In the first to fourth configuration examples described below, first electrode group 110 may represent each of the plurality of first electrodes 110a, . . . , 110N. Similarly, second electrode group 210 in the first configuration example may indicate each of the plurality of second electrodes 210a, . . . , 210N.

FIG. 7 is a diagram illustrating an example of ideal electrode resistance value curve Gr1. Electrode resistance value curve Gr1 is a diagram illustrating the electrode resistance value of each of first electrode group 110 and second electrode group 210 in the width direction. First electrode group 110 and second electrode group 210 illustrated in FIG. 7 have different electrode resistance values depending on the position in the width direction of first electrode group 110 in the A-A cross section and the position in the width direction of second electrode group 210 in the C-C′ cross section, respectively. Electrode resistance value curve Gr1 illustrated in FIG. 7 is a diagram illustrating an ideal electrode resistance value of each of first electrode group 110 and second electrode group 210.

First electrode group 110 includes first substrate 111 on the surface in the Z direction. Second electrode group 210 includes second substrate 211 on the surface in the −Z direction. Each of first electrode group 110 and second electrode group 210 has an electrode resistance value of a different magnitude depending on the position in the width direction. Electrode resistance value VRa at center La is the minimum value in the width direction of first electrode 110a. Electrode resistance value VRb at intermediate Lb is larger than electrode resistance value VRa and smaller than electrode resistance value VRc. Electrode resistance value VRc at end Lc is the maximum value (infinity) in the width direction of first electrode 110a. Note that electrode resistance value VRa at center La is, for example, 0.01Ω.

In each of first electrode group 110 and second electrode group 210 having electrode resistance value curve Gr1 illustrated in FIG. 7, the electrode resistance value at center La in the width direction is small, and the electrode resistance value at end Lc is infinitely large, so that the electric field is less likely to concentrate on the end (edge). The electrode resistance value indicated by electrode resistance value curve Gr1 smoothly changes from center La toward end Lc in the width direction of each of first electrode group 110 and second electrode group 210. Thereby, EC element 100 can reduce an increase and decrease in the amount of deposition of metal OB1 (display unevenness) based on the difference in the electrode resistance value from center La toward end Lc.

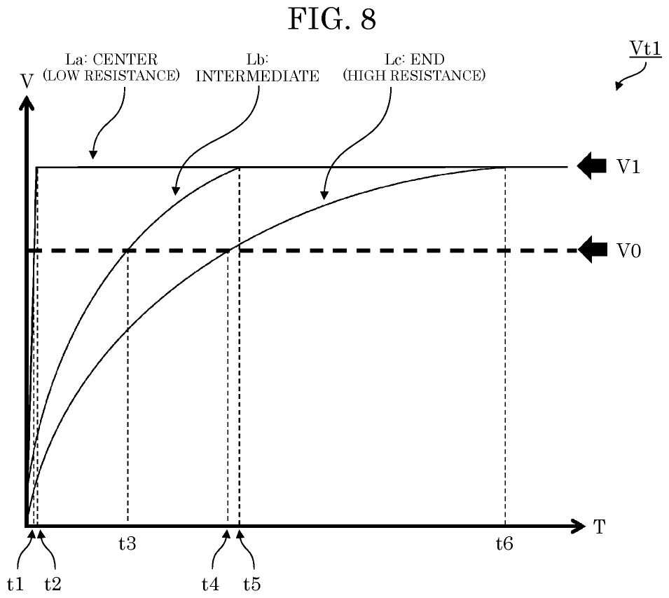

FIG. 8 is a graph illustrating temporal change graph Vt1 of the potential in the width direction of each of first electrode group 110 and second electrode group 210. Each of first electrode group 110 and second electrode group 210 illustrated in FIG. 8 has electrode resistance value curve Gr1 illustrated in FIG. 7.

Temporal change graph Vt1 illustrates a state of temporal change of the potential in the electrode resistance value of each of center La, intermediate Lb, and end Lc in the width direction of each of first electrode group 110 and second electrode group 210 having electrode resistance value curve Gr1. Deposition start potential V0 is a potential at which metal OB1 starts deposition. Applied voltage V1 indicates a voltage applied to each of first electrode group 110 and second electrode group 210.

The temporal change of the potential in the width direction of each of first electrode group 110 and second electrode group 210 having electrode resistance value curve Gr1 will be described. The potential at center La reaches deposition start potential V0 at time t1 after application of applied voltage V1 and further reaches a potential equal to applied voltage V1 at time t2. The potential at intermediate Lb reaches deposition start potential V0 at time t3 after application of applied voltage V1 and further reaches a potential having the same value as applied voltage V1 at time t5. The potential at end Lc reaches deposition start potential V0 at time t4 after application of applied voltage V1 and further reaches a potential having the same value as applied voltage V1 at time t6.

In each of first electrode group 110 and second electrode group 210 having electrode resistance value curve Gr1, metal OB1 starts to be deposited from center La toward end Lc with a predetermined time difference. In each of first electrode group 110 and second electrode group 210 having electrode resistance value curve Gr1, when the potential at center La is compared with the potential at end Lc, it takes more time for the potential at end Lc to reach the same potential (applied voltage V1) than at center La. As a result, each of first electrode group 110 and second electrode group 210 having electrode resistance value curve Gr1 can control the time until metal OB1 starts to be deposited and the amount of deposition of metal OB1 to reduce the occurrence of display unevenness.

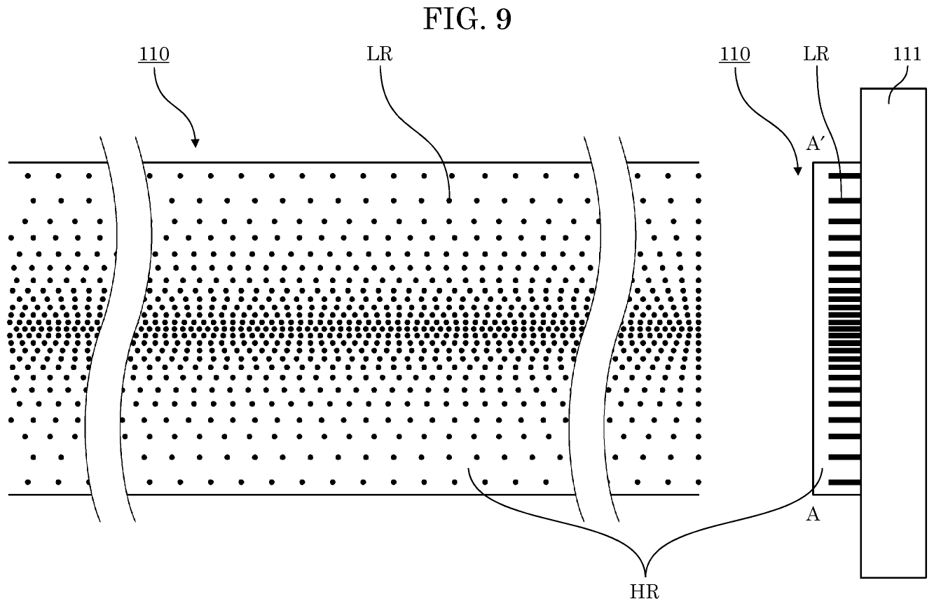

FIG. 9 is a view illustrating an arrangement example of low-resistance electrode member LR in the A-A′ cross section. First electrode group 110 illustrated in FIG. 9 includes each of the plurality of low-resistance electrode members LR and high-resistance electrode member HR and has an electrode resistance value close to electrode resistance value curve Gr1. Although only first electrode group 110 is illustrated in FIG. 9, second electrode group 210 may have a similar configuration.

Each of the plurality of low-resistance electrode members LR is an electrode member having translucency and is made of, for example, ITO. Each of the plurality of low-resistance electrode members LR is arranged at a different arrangement density in the width direction of first electrode group 110 in order to obtain the electrode resistance value indicated by electrode resistance value curve Gr1 in FIG. 7. Each of the plurality of low-resistance electrode members LR is arranged so as to have the largest density at the central position in the width direction of first electrode group 110 and is arranged so as to have the smallest density at the end.

High-resistance electrode member HR is an electrode member having translucency and is made of, for example, ITO doped with SiO₂, SnO₂, or the like. High-resistance electrode member HR is provided so as to cover each of the plurality of low-resistance electrode members LR and forms a rectangular first electrode group 110.

As described above, in first electrode group 110 illustrated in FIG. 8, at the end where the arrangement density of each of the plurality of low-resistance electrode members LR is small, the proportion occupied by high-resistance electrode member HR increases, and the electrode resistance value increases. On the other hand, in first electrode group 110, at the central position where the arrangement density of each of the plurality of low-resistance electrode members LR is large, the proportion occupied by high-resistance electrode member HR decreases, and the electrode resistance value decreases. As a result, first electrode group 110 can have an electrode resistance value close to electrode resistance value curve Gr1 illustrated in FIG. 7. Therefore, EC element 100 can suppress the electric field at the edge (end) in the width direction of the electrode at the time of driving and reduce the display unevenness to achieve the high-quality display.

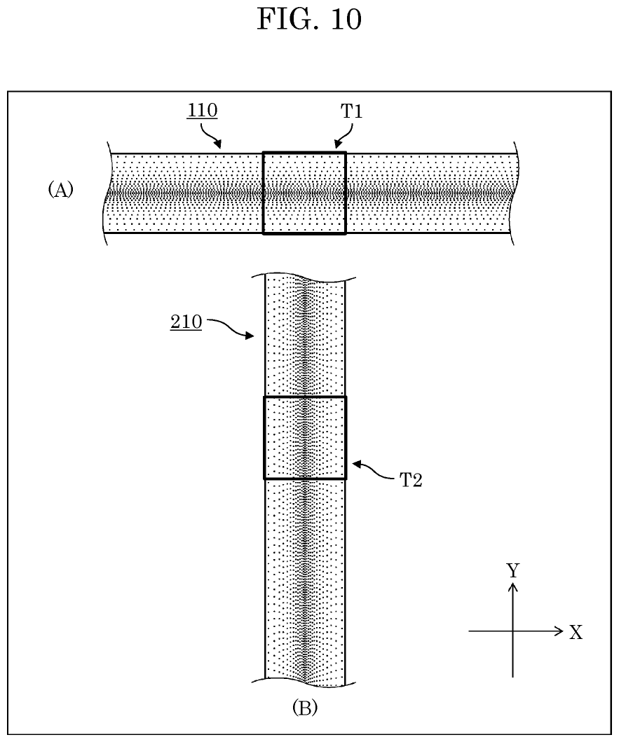

FIG. 10 is a diagram illustrating an example of the arrangement of low-resistance electrode members LR. Part (A) of FIG. 10 illustrates a state of arrangement of each of the plurality of low-resistance electrode members LR in first electrode group 110. Part (B) of FIG. 10 illustrates a state of arrangement of each of the plurality of low-resistance electrode members LR in second electrode group 210.

First electrode group 110 is formed to include each of a plurality of low-resistance electrode members LR having different arrangement densities in the width direction of the electrodes. First electrode group 110 intersects with second electrode group 210 illustrated in part (B) of FIG. 10 in pixel region T1.

Second electrode group 210 is formed to include each of a plurality of low-resistance electrode members LR having different arrangement densities in the width direction of the electrodes. Second electrode group 210 intersects with first electrode group 110 illustrated in part (A) of FIG. 10 in pixel region T2. Note that second electrode group 210 may be formed by including each of the plurality of low-resistance electrode members LR and high-resistance electrode member HR or may be integrally formed by other resistance electrode members having different resistance values.

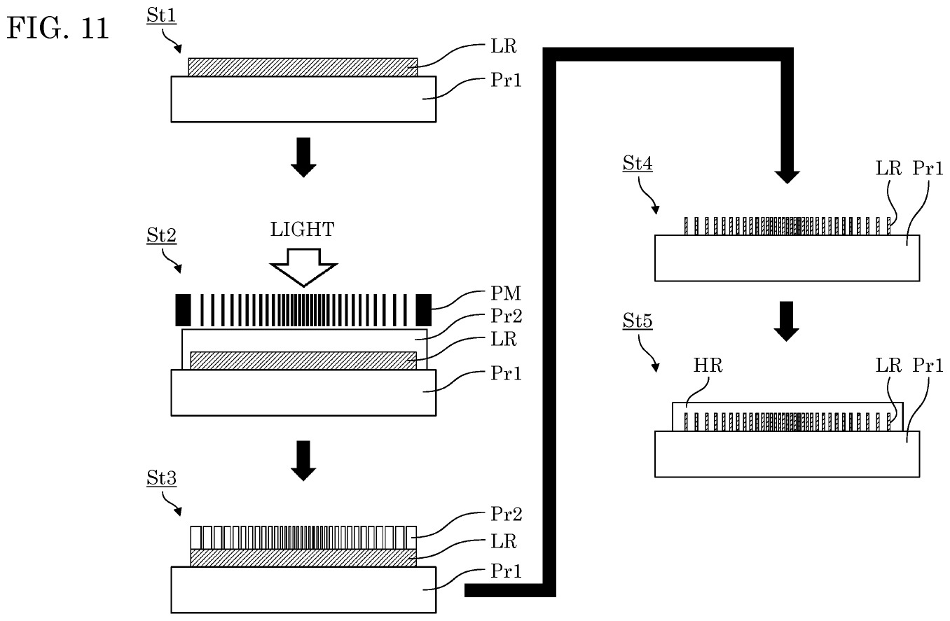

FIG. 11 is a view illustrating an example of a manufacturing procedure of the electrode including low-resistance electrode members LR and high-resistance electrode member HR. First electrode group 110 described with reference to FIG. 11 is formed to include each of the plurality of low-resistance electrode members LR and high-resistance electrode member HR and has an electrode resistance value indicated by electrode resistance value curve Gr1. Similarly to FIG. 9, FIG. 11 illustrates only first electrode group 110, but second electrode group 210 may have the same configuration and manufacturing method.

In the manufacturing procedure illustrated in step St1, low-resistance electrode member LR is sputtered and laminated on base material Pr1. Base material Pr1 is, for example, a glass material. Although base material Pr1 according to the first exemplary embodiment will be described using glass having high dimensional stability as an example, base material Pr1 is not limited thereto but may be another material.

In the manufacturing procedure illustrated in step St2, photoresist Pr2 is applied to the surface of low-resistance electrode member LR (the surface opposite to the surface provided with base material Pr1). Low-resistance electrode member LR having the surface coated with photoresist Pr2 further includes a photomask PM on the upper surface and is irradiated with light such as ultraviolet light from the direction of an arrow illustrated in FIG. 11 (resist development).

Photoresist Pr2 described above is a photosensitive anticorrosion film. Photoresist Pr2 is provided by being applied to the surface of low-resistance electrode member LR. In photoresist Pr2, a portion irradiated with light is cured. Cured photoresist Pr2 remains on the surface of low-resistance electrode member LR without being dissolved in a developer (organic solvent). In the manufacturing procedure example of first electrode group 110 according to the first exemplary embodiment, although the manufacturing procedure example using negative photoresist Pr2 has been described, the manufacturing procedure example is not limited to the negative type but may be a positive type.

Photomask PM is disposed on low-resistance electrode member LR coated with photoresist Pr2. Photomask PM has translucency and is formed in a plate shape using, for example, glass, quartz, or the like. Photomask PM is a pattern original plate having a predetermined pattern. Photomask PM forms a pattern on photoresist Pr2 by light irradiation.

In the manufacturing procedure illustrated in step St3, in photoresist Pr2, only a portion irradiated with light is cured in accordance with the pattern of photomask PM. In photoresist Pr2, only the uncured portion is dissolved by a developer (organic solvent), and only the cured portion remains on low-resistance electrode member LR.

In the manufacturing procedure illustrated in step St4, a portion of low-resistance electrode member LR where photoresist Pr2 remains is removed, and each of the plurality of low-resistance electrode members LR remains. Note that each of the remaining plurality of low-resistance electrode members LR has the highest density at the central position.

In the manufacturing procedure illustrated in step St5, high-resistance electrode member HR is laminated on each of the plurality of low-resistance electrode members LR by sputtering. Thus, each of the plurality of low-resistance electrode members LR is covered by lamination of high-resistance electrode members HR having a higher resistance value than low-resistance electrode members LR and forms first electrode group 110 or second electrode group 210 having a rectangular shape (plate shape).

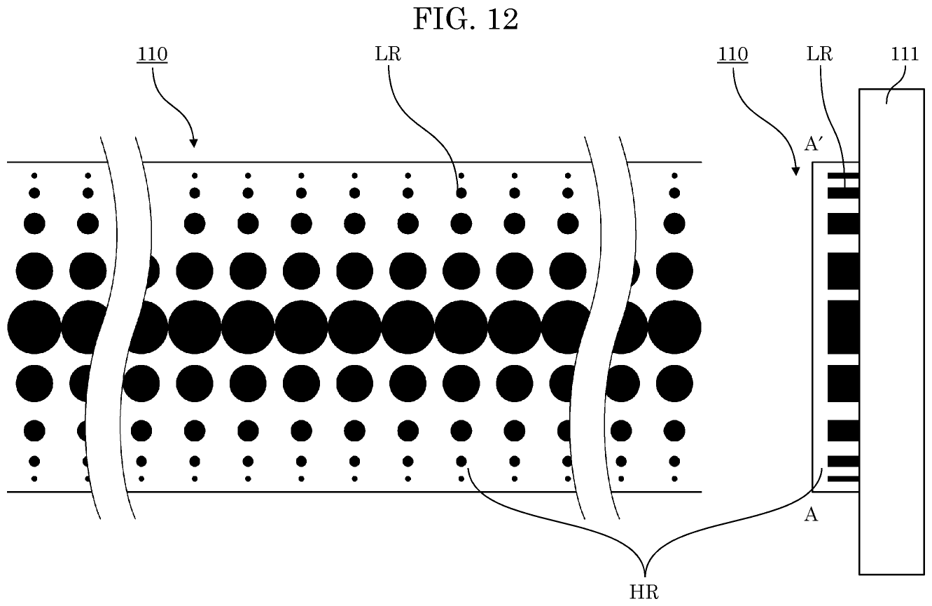

Another arrangement example of each of the plurality of low-resistance electrode members LR included in first electrode group 110 will be described with reference to FIG. 12. FIG. 12 is a view illustrating an arrangement example of low-resistance electrode members LR having different sizes. The plurality of low-resistance electrode members LR illustrated in FIG. 12 are formed to be largest at the central position in the width direction of first electrode group 110 and formed to be smallest at the end.

Each of the plurality of low-resistance electrode members LR having different sizes illustrated in FIG. 12 can reduce a number of low-resistance electrode members LR to be disposed, so that the pattern formed on photomask PM used in the manufacturing procedure illustrated in FIG. 11 can be simplified.

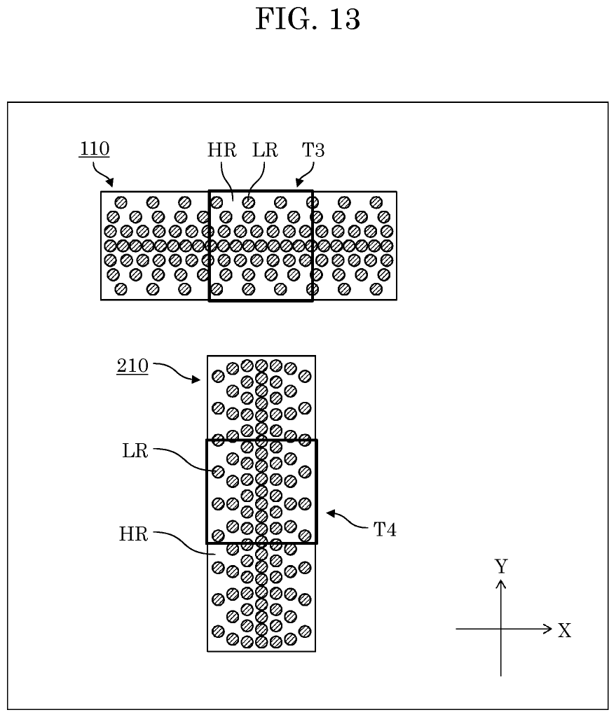

An example of another arrangement pattern of each of the plurality of low-resistance electrode members LR included in each of first electrode group 110 and second electrode group 210 will be described with reference to FIG. 13. FIG. 13 is a view illustrating an arrangement pattern example of low-resistance electrode members LR in pixel regions T3, T4.

The plurality of low-resistance electrode members LR illustrated in FIG. 13 have predetermined arrangement patterns illustrated in the respective regions of pixel regions T3, T4. The arrangement pattern of low-resistance electrode members LR in pixel regions T3, T4 is repeated in the longitudinal direction. Each of the plurality of low-resistance electrode members LR is disposed such that the electrode resistance value at the central position in the width direction of pixel region T1 decreases. In the arrangement pattern of low-resistance electrode members LR illustrated in FIG. 13, the plurality of low-resistance electrode members LR are arranged side by side at the edge in the longitudinal direction of first electrode group 110. Therefore, each of the plurality of low-resistance electrode members LR can suppress the electric field at the edge in the width direction and the longitudinal direction of each of pixel regions T3, T4 and reduce the display unevenness to achieve the high-quality display.

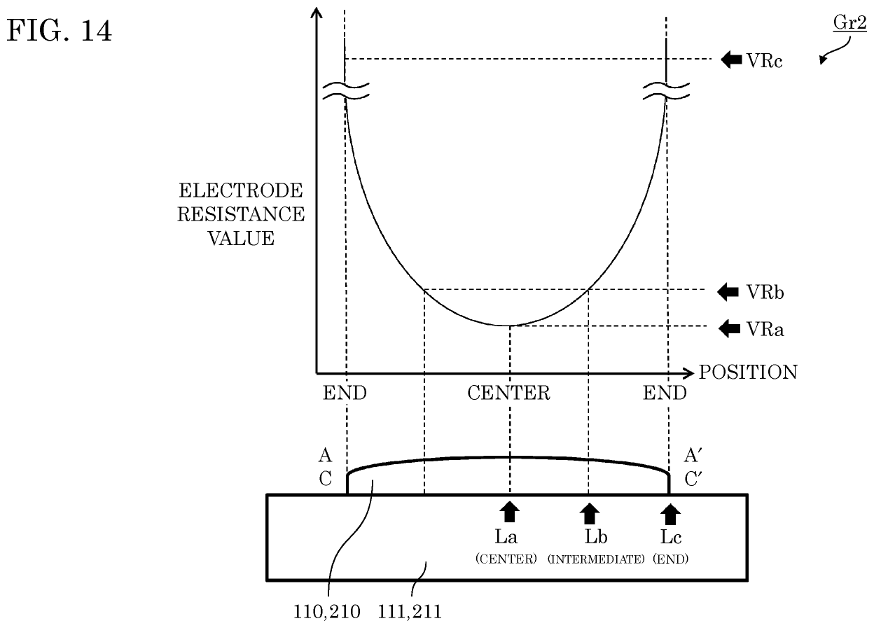

FIG. 14 illustrates a modification of the shape of each of first electrode group 110 and second electrode group 210 for obtaining electrode resistance value curve Gr2 approximate to ideal electrode resistance value curve Gr1 illustrated in FIG. 7.

In each of first electrode group 110 and second electrode group 210 illustrated in FIG. 14, the surface opposite to the surface including each of first substrate 111 and second substrate 211 has a convex shape. The electrode resistance value of each of first electrode group 110 and second electrode group 210 changes in accordance with the thickness of each of first electrode group 110 and second electrode group 210, and the electrode resistance value decreases as the thickness increases. The thickness of each of first electrode group 110 and second electrode group 210 is the largest at center La and decreases toward end Lc. Thereby, the electrode resistance value in the width direction of each of first electrode group 110 and second electrode group 210 becomes an electrode resistance value curve Gr2. Therefore, EC element 100 according to the first configuration example can suppress the electric field at the edge (end) in the width direction of the electrode at the time of driving and reduce the display unevenness to achieve the high-quality display.

Although each of first electrode group 110 and second electrode group 210 is illustrated in FIG. 14, one of first electrode group 110 and second electrode group 210 may be formed in a convex shape depending on the application. For example, EC element 100 may be formed to have a convex shape only on the surface (e.g., first electrode group 110) used by the user. Furthermore, for example, in a case where EC element 100 is used with its optical state being a light-shielding state, only second electrode group 210 may be formed to have a convex shape.

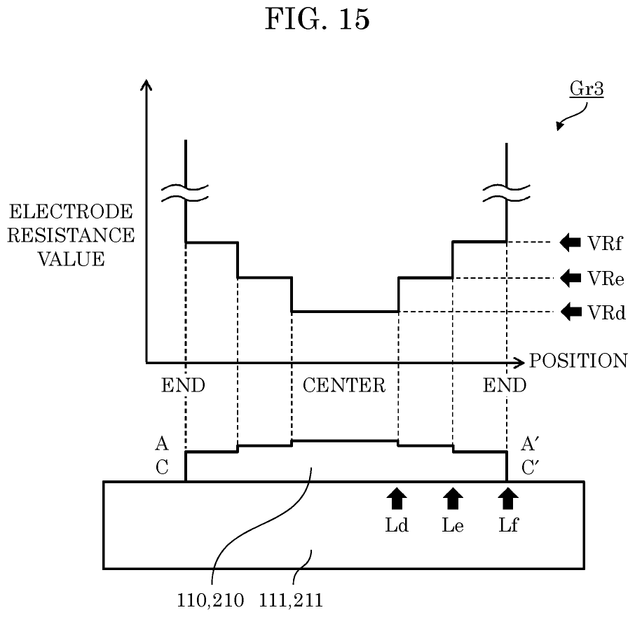

FIG. 15 illustrates other shapes of first electrode group 110 and second electrode group 210 for the purpose of approximately obtaining ideal electrode resistance value curve Gr1 illustrated in FIG. 7.

Each of first electrode group 110 and second electrode group 210 illustrated in FIG. 15 forms a plurality of steps so as to have a plurality of different electrode thicknesses in the width direction. The electrode resistance value in the width direction of each of first electrode group 110 and second electrode group 210 changes in accordance with the thickness of the electrode. The electrode resistance value decreases as the thickness of the electrode increases.

Electrode resistance value line Gr3 has an electrode resistance value of a different magnitude in accordance with the step formed in each of first electrode group 110 and second electrode group 210. Electrode resistance value VRd near-center Ld has a minimum value in the width direction of each of first electrode group 110 and second electrode group 210. Electrode resistance value VRe in intermediate portion Le is larger than electrode resistance value VRd and smaller than electrode resistance value VRf. Electrode resistance value VRf at end Lf has a maximum value in the width direction of each of first electrode group 110 and second electrode group 210. As a result, the electrode resistance value in the width direction of each of first electrode group 110 and second electrode group 210 becomes electrode resistance value line Gr3.

Each of first electrode group 110 and second electrode group 210 in which the plurality of steps is formed as illustrated in FIG. 15 is more easily manufactured as compared with the case of forming in the convex shape illustrated in FIG. 14. Each of the plurality of steps can be formed by stacking high-resistance electrode members HR in accordance with a number of steps. In addition, although FIG. 15 illustrates an example in which three steps are formed, the number of steps may be more than three. Thus, the electrode resistance value of each of first electrode group 110 and second electrode group 210 changes more smoothly in the width direction. Therefore, EC element 100 in the first configuration example can suppress the electric field at the edge (end) in the width direction of the electrode at the time of driving and reduce the display unevenness to achieve the high-quality display.

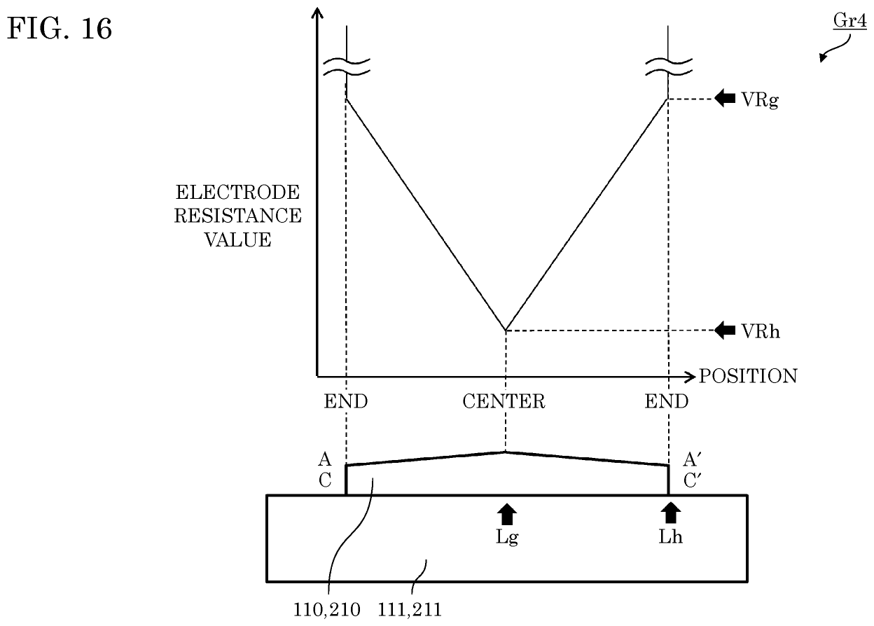

Further, FIG. 16 illustrates an example of each of first electrode group 110 and second electrode group 210 formed in other shapes.

FIG. 16 illustrates an example in which each of first electrode group 110 and second electrode group 210 is formed to have a triangular cross-sectional shape. The electrode resistance value in the width direction of each of first electrode group 110 and second electrode group 210 illustrated in FIG. 16 changes as electrode resistance value line Gr4 from center Lg toward end Lh. Electrode resistance value VRg at center Lg is the minimum value in the width direction of each of first electrode group 110 and second electrode group 210. Electrode resistance value VRh at end Lh has a maximum value in the width direction of each of first electrode group 110 and second electrode group 210. Thereby, the electrode resistance value of each of first electrode group 110 and second electrode group 210 changes linearly with respect to the width direction. Therefore, EC element 100 in the first configuration example can suppress the electric field at the edge (end) in the width direction of the electrode at the time of driving and reduce the display unevenness to achieve the high-quality display.

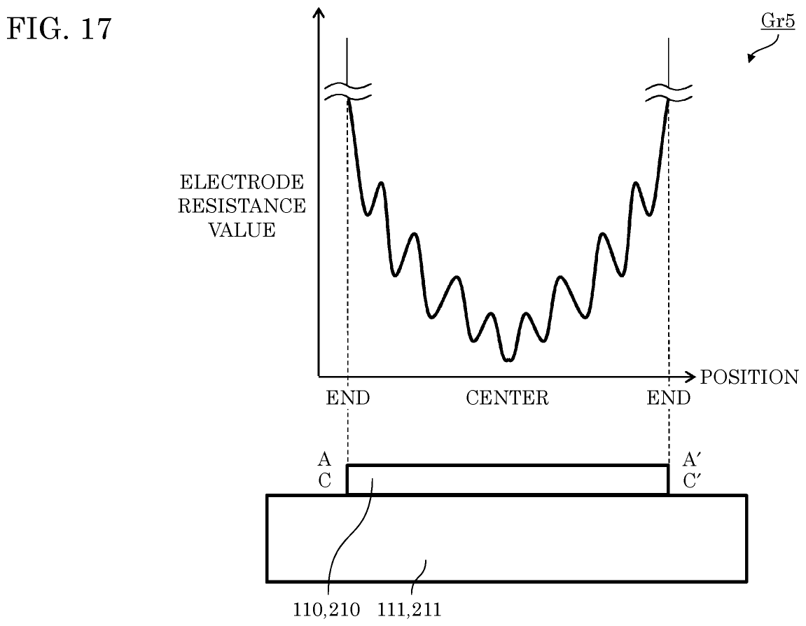

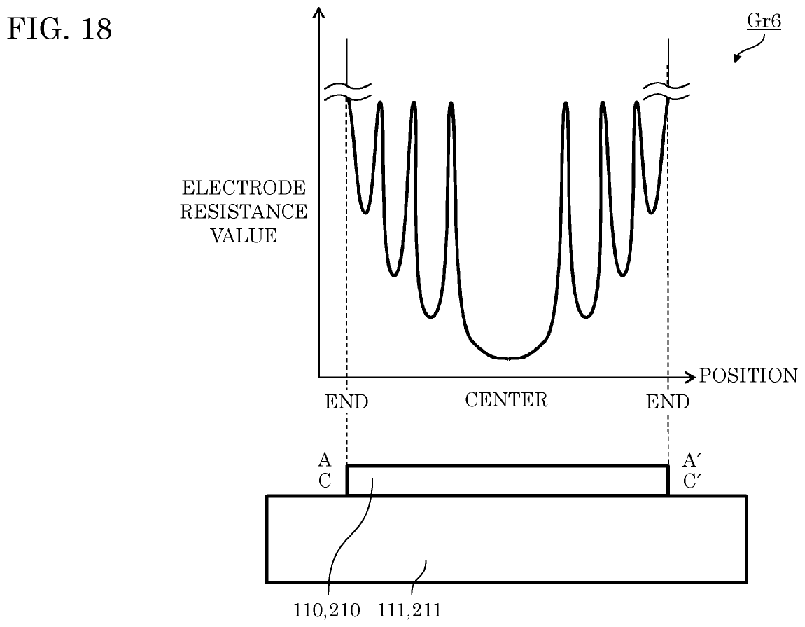

Each of electrode resistance value curves Gr5, Gr6 illustrated in FIGS. 17 and 18 illustrates a change in the electrode resistance value in the width direction of each of first electrode group 110 and second electrode group 210 formed including each of the plurality of low-resistance electrode members LR and high-resistance electrode member HR.

FIG. 17 is a diagram illustrating an example of electrode resistance value curve Gr5 according to the arrangement pattern of low-resistance electrode member LR. An electrode resistance value curve Gr5 illustrated in FIG. 17 indicates a change in the electrode resistance value in the width direction according to the size, arrangement density, and arrangement pattern of each of the plurality of low-resistance electrode members LR included in each of first electrode group 110 and second electrode group 210. In each of first electrode group 110 and second electrode group 210 illustrated in FIG. 17, the arrangement density of each of the plurality of low-resistance electrode members LR is large at the central position in the width direction, and the arrangement density is small at the end. Therefore, as indicated by electrode resistance value curve Gr5, the electrode resistance value of each of first electrode group 110 and second electrode group 210 in the width direction has a value in which the electrode resistance value at the end is relatively larger than the electrode resistance value at the central position.

FIG. 18 is a diagram illustrating an example of electrode resistance value curve Gr6 according to the arrangement pattern of low-resistance electrode member LR. Electrode resistance value curve Gr6 illustrated in FIG. 18 is achieved by, for example, the size and arrangement pattern of each of the plurality of low-resistance electrode members LR included in first electrode group 110 as illustrated in FIG. 12. In electrode resistance value curve Gr6, similarly to electrode resistance value curve Gr5, the electrode resistance value in the width direction of each of first electrode group 110 and second electrode group 210 is a value in which the electrode resistance value at the end is relatively larger than the electrode resistance value at the central position.

### Second Configuration Example

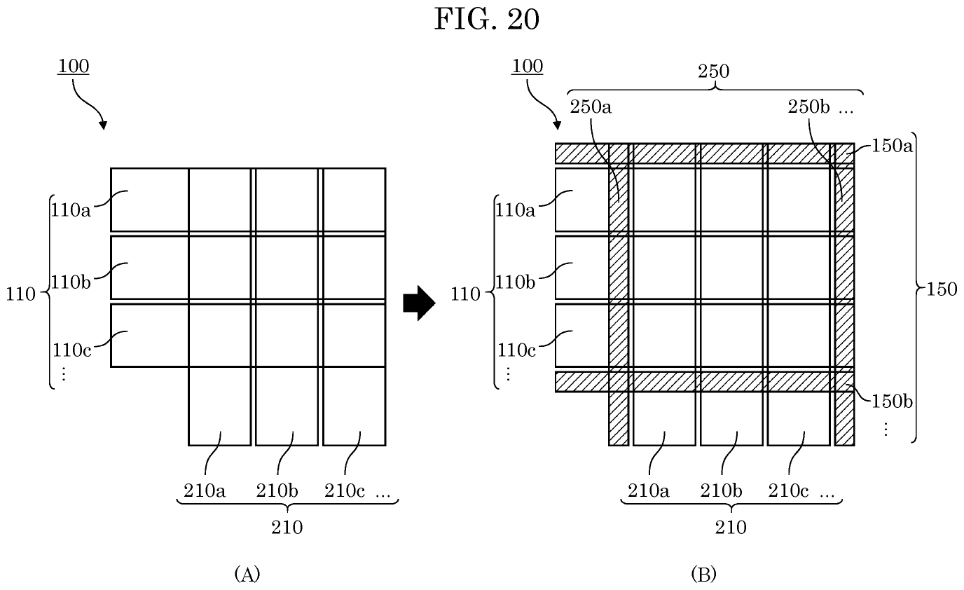

EC element 100 in a second configuration example according to the first exemplary embodiment will be described. In the second configuration example, EC element 100 has a structure for reducing display unevenness W1, W2 as illustrated in part (B) of FIG. 19. Hereinafter, the second configuration example will be described with reference to FIGS. 19 and 20.

FIG. 19 is a view illustrating an example of display unevenness W1, W2 of EC element 100. Part (A) of FIG. 19 illustrates a state before passive-matrix driving is performed on each of the plurality of first electrodes 110a, . . . , 110N and each of the plurality of second electrodes 210a, . . . , 210N constituting EC element 100. First electrode group 110 and second electrode group 210 are disposed to face each other in the vertical direction. Part (B) of FIG. 19 illustrates a state of display unevenness W1, W2 that has occurred after the passive-matrix driving of EC element 100.

In EC element 100 illustrated in part (B) of FIG. 19, metal OB1 is deposited in each of display pixels Pca, Pac by passive-matrix driving. Display unevenness W1 has occurred in the pixel adjacent to display pixel Pca. In display pixel Pca, the electric field is locally concentrated on the edge of the pixel, the potential becomes sufficient for depositing metal OB1, and extra metal OB1 is deposited to cause the occurrence of display unevenness W1. In display pixel Pac, display unevenness W2 has occurred at the edge of the pixel. In display pixel Pac, partially concentrated and deposited metal OB1 partially forms a thick metal film, and display unevenness W2 has occurred.

FIG. 20 illustrates the second configuration example of EC element 100 for reducing display unevenness W1, W2 illustrated in part (B) of FIG. 19. Part (A) of FIG. 20 illustrates EC element 100 before the application of the second configuration example.

Part (B) of FIG. 20 illustrates EC element 100 including a plurality of non-display electrode groups 150, 250 that have translucency and in which metal OB1 is not deposited when a voltage is applied. Each of the plurality of non-display electrode groups 150, 250 has a smaller width than first electrode 110a and second electrode 210a. The electrode resistance value of each of the plurality of non-display electrode groups 150, 250 is substantially infinite.

Non-display electrode 150a of non-display electrode group 150 is disposed adjacent to first electrode 110a and on the outermost periphery (edge) of EC element 100. Non-display electrode 250a of non-display electrode group 250 is disposed adjacent to second electrode 210a and along the outermost periphery (edge) of EC element 100. Non-display electrode 150b of non-display electrode group 150 is disposed between first electrode 110c and first electrode 110d (not illustrated). Non-display electrode 250b of non-display electrode group 250 is disposed between second electrode 210c and second electrode 210d (not illustrated). In part (B) of FIG. 20, four non-display electrodes 150a, 150b, 250a, 250b are illustrated, and the other non-display electrodes are omitted in order to simplify the description.

A plurality of non-display electrodes may be provided in each of first electrode group 110 and second electrode group 210 and may be disposed for each predetermined number of electrodes, for example. As a result, EC element 100 can prevent the electric field concentration at the edges of display pixels Pca, Pac illustrated in part (B) of FIG. 19 and reduce display unevenness W1, W2 to achieve the high-quality display.

Three first electrodes and three second electrodes are illustrated in each of first electrode group 110 and second electrode group 210 illustrated in FIGS. 19 and 20 in order to simplify the description, but it is needless to say that a number of first electrodes and a number of second electrodes are not limited to three.

### Third Configuration Example

A third configuration example of EC element 100 according to the first exemplary embodiment will be described. In the third configuration example, each of the plurality of first electrodes 110a, . . . , 110N and each of the plurality of second electrodes 210a, . . . , 210N constituting EC element 100 have a structure for reducing display unevenness W3, W4 as illustrated in part (B) of FIG. 21. Hereinafter, the third configuration example will be described with reference to each of FIGS. 21 to 26.

FIG. 21 is a view illustrating an example of display unevenness W3, W4 of EC element 100. Part (A) of FIG. 21 illustrates a state before passive-matrix driving is performed on each of the plurality of first electrodes 110a, . . . , 110N and each of the plurality of second electrodes 210a, . . . , 210N constituting EC element 100. First electrode group 110 and second electrode group 210 are disposed to face each other in the vertical direction. Part (B) of FIG. 21 illustrates a state of display unevenness W3, W4 that has occurred after the passive-matrix driving of EC element 100.

In EC element 100 illustrated in part (B) of FIG. 21, metal OB1 is deposited outside the display region of display pixel Pbb by passive-matrix driving. In display pixel Pbb, display unevenness W3, W4 occurs in adjacent pixels. The electric field is locally concentrated in four corners of display pixel Pbb, and metal OB1 is deposited in the adjacent pixels to cause the occurrence of display unevenness W3, W4.

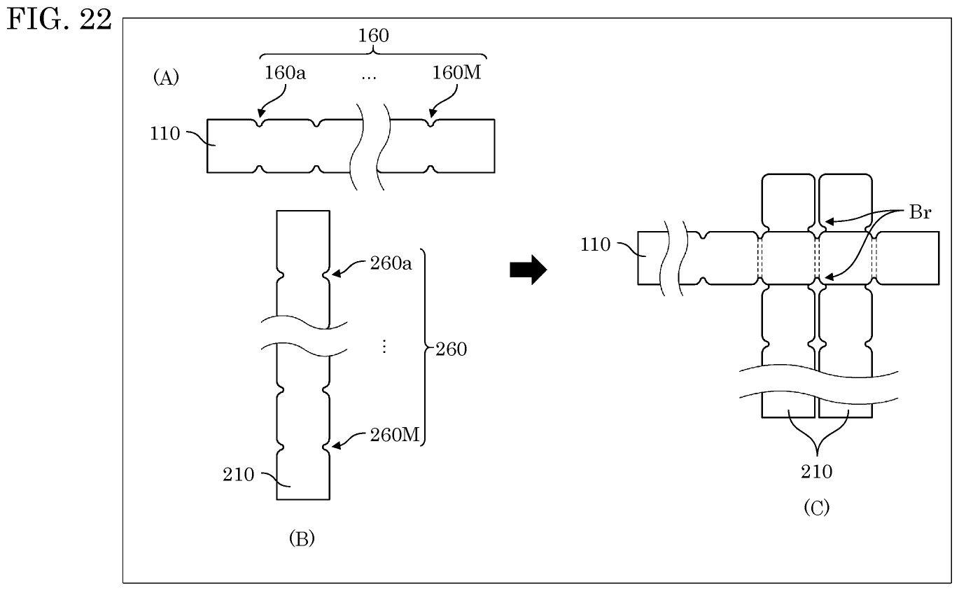

FIG. 22 illustrates a third configuration example of EC element 100 for reducing display unevenness W3, W4 illustrated in part (B) of FIG. 21. Part (A) of FIG. 22 is a view illustrating first electrode group 110 in which a plurality of notches 160a, . . . , 160M (notch group 160) are provided along the longitudinal direction. Part (B) of FIG. 22 is a view illustrating second electrode group 210 in which a plurality of notches 260a, . . . , 260M (notch group 260) are provided along the longitudinal direction. Part (C) of FIG. 22 is a view illustrating void Br formed by notch groups 160, 260 when first electrode group 110 and second electrode group 210 are disposed to face each other. Note that notch groups 160, 260 are provided in first electrode group 110 and second electrode group 210, respectively, such that void Br has a round shape when formed.

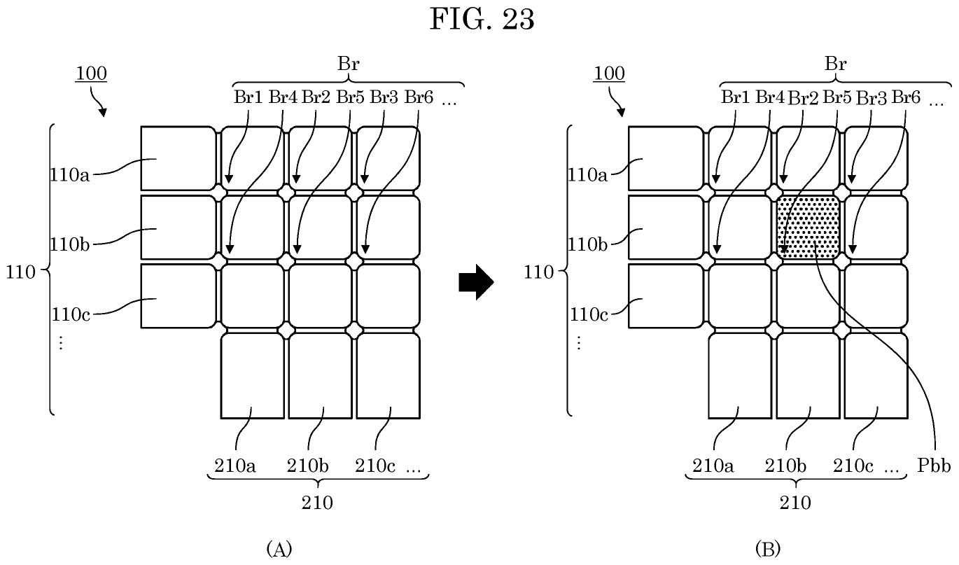

FIG. 23 illustrates void Br of EC element 100 and deposition of metal OB1 in display pixel Pbb in the third configuration example.

Part (A) of FIG. 23 illustrates a state before EC element 100 to which the third configuration example has been applied performs passive-matrix driving. In EC element 100, first electrode group 110 and second electrode group 210 are disposed to face each other in the vertical direction (Z direction). In EC element 100, a plurality of voids Br1, Br2, Br3, Br4, Br5, Br6 are formed by notch groups 160, 260 provided in first electrode group 110 and second electrode group 210, respectively. As a result, in the display pixel, each of the plurality of voids Br1, Br2, Br3, Br4, Br5, Br6 is formed in a round shape with respect to the four corners where the potential is likely to concentrate, and the potential can be dispersed. Therefore, EC element 100 in the third configuration example can prevent deposition (interference) of metal OB1 with respect to the adjacent pixel.

Part (B) of FIG. 23 illustrates a state of EC element 100 in the third configuration example at the time of performing passive-matrix driving. In display pixel Pbb, deposition (interference) of metal OB1 with respect to the adjacent pixel is prevented by each of the plurality of voids Br2, Br3, Br5, Br6. As described above, EC element 100 in the third configuration example can suppress the electric field at the edge (four corners of the pixel) of the electrode at the time of driving and reduce the display unevenness to achieve the high-quality display.

### Fourth Configuration Example

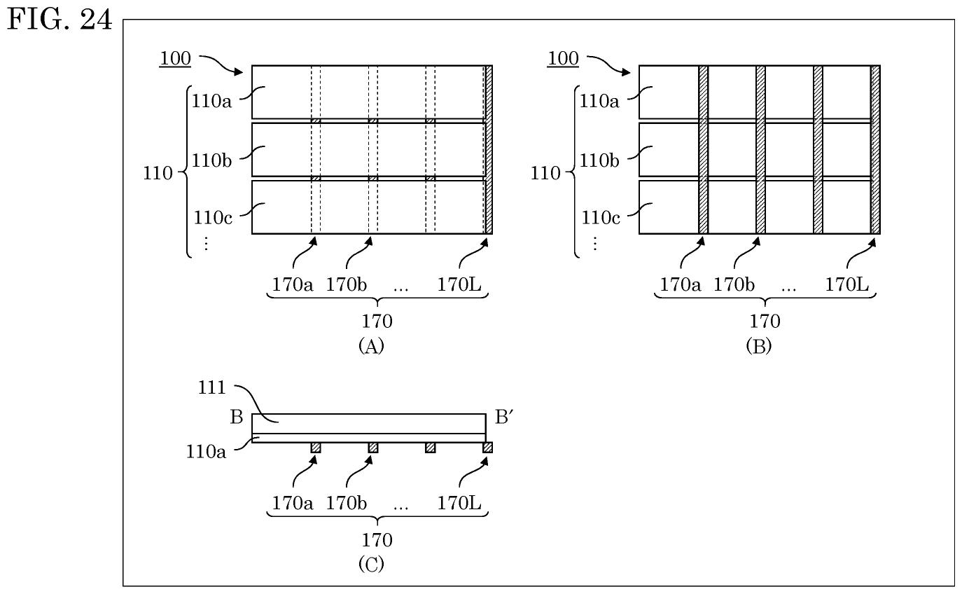

A fourth configuration example of EC element 100 according to the first exemplary embodiment will be described. In the fourth configuration example, EC element 100 has a structure for reducing each of display unevenness W3, W4 as illustrated in part (B) of FIG. 21. Hereinafter, a fourth configuration example will be described with reference to each of FIGS. 24 to 26. Note that display unevenness W3, W4 illustrated in part (B) of FIG. 21 is the same as the content described in the third configuration example and will thus be omitted in the following description.

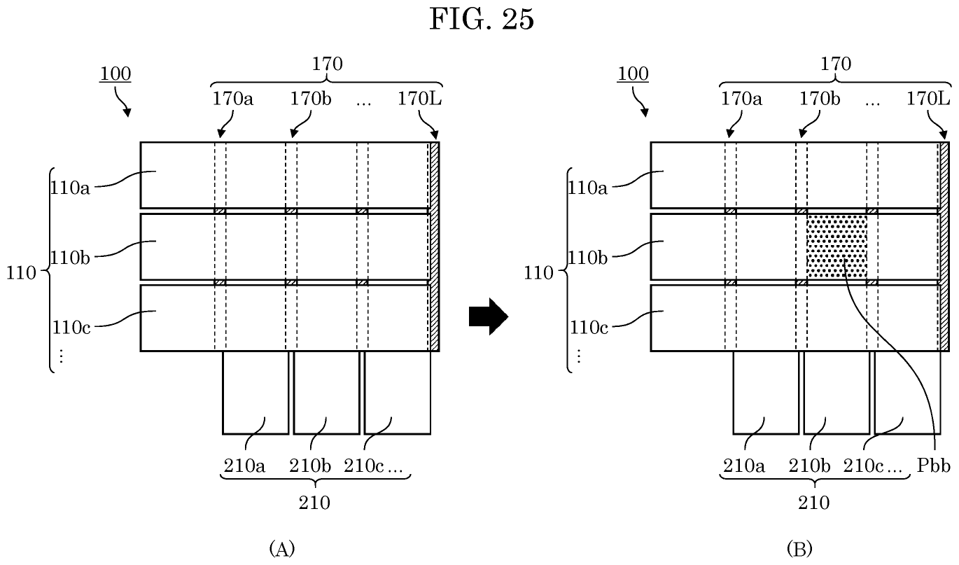

FIGS. 24 and 25 illustrate the fourth configuration example of EC element 100 for reducing display unevenness W3, W4 illustrated in part (B) of FIG. 21.

Part (A) of FIG. 24 is a view of first electrode group 110 in the fourth configuration example as viewed from the user (cf. FIG. 1, arrow K). Part (B) of FIG. 24 is a view of first electrode group 110 illustrated in part (A) of FIG. 24 as viewed from the opposite side (second electrode group 210). Part (C) of FIG. 24 is a B-B′ cross-sectional view of first electrode group 110 in the fourth configuration example. In the fourth configuration example, insulating film group 170 is disposed in first electrode group 110.

Part (A) of FIG. 25 is a view of EC element 100 in the fourth configuration example as viewed from the user (cf. FIG. 1, arrow K). Part (B) of FIG. 25 is a view illustrating a state of display pixel Pbb in EC element 100 of the fourth configuration example.

First electrode group 110 includes first substrate 111 on one surface and insulating film group 170 on the other surface facing second electrode group 210. Insulating film group 170 includes a plurality of insulating films 170a, 170b, . . . , 170L. Each of the plurality of second electrodes 210a, . . . , 210N is arranged with a predetermined gap from the second electrode. The plurality of insulating films 170a, . . . 170L are arranged so as to straddle a plurality of gaps formed between the plurality of second electrodes 210a, . . . , 210N facing each other. As a result, each of the plurality of first electrodes 110a, . . . , 110N can prevent the concentration of the electric field on the gap portion formed by each of the plurality of second electrodes 210a, . . . , 210N. Therefore, EC element 100 of the fourth configuration example can reduce each of the plurality of display unevenness W3, W4 with respect to the display pixel in the longitudinal direction of first electrode group 110 adjacent to display pixel Pbb.

In addition, a number of insulating films constituting insulating film group 170 is preferably larger by one than a number of second electrodes constituting the second electrode group. In such a case, insulating film 170a is disposed so as to straddle between second electrode 210a and spacer 300. Insulating film 170L is disposed so as to straddle between second electrode 210N and spacer 300. Thus, EC element 100 of the fourth configuration example can prevent the concentration of the electric field on the edge formed by spacer 300 and the second electrode disposed on the outermost periphery where the electric field is most likely to be concentrated.

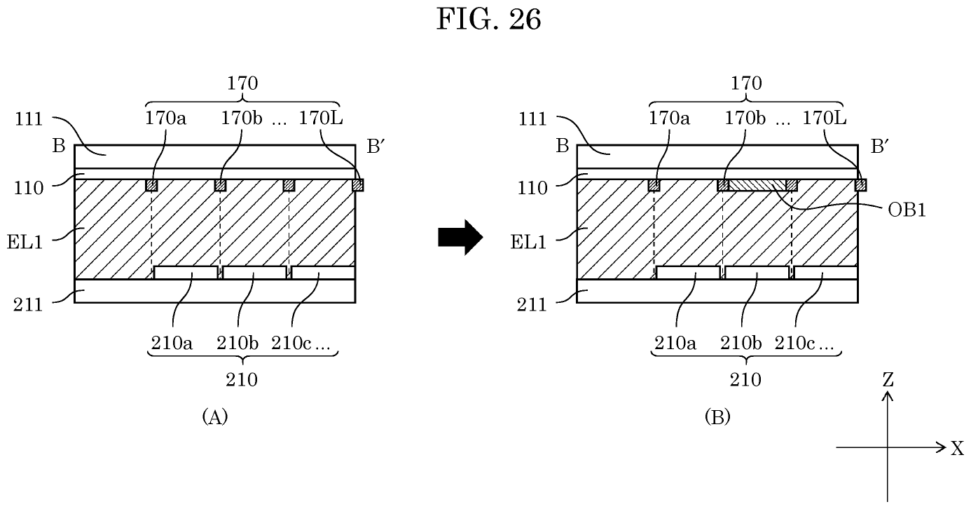

A state of deposition of metal OB1 in the fourth configuration example will be described with reference to FIG. 26. FIG. 26 is a view illustrating an example of deposition of metal OB1 of the EC element 100 in the fourth configuration example.

A plurality of insulating films 170a, 170b, . . . , 170L is disposed on the surface of first electrode group 110 facing second electrode group 210. The plurality of insulating films 170a, . . . , 170L are arranged corresponding to a plurality of gaps formed between the plurality of second electrodes 210a, . . . , 210N facing each other.

First electrode group 110 in the fourth configuration example accumulates negative charges according to the applied voltage on the surface excluding the places where the plurality of insulating films 170a, . . . , 170L are arranged. Metal OB1 contained in electrolytic solution EL1 starts to be deposited only in a portion where negative charges are accumulated in the surface of first electrode group 110. Therefore, as illustrated in part (B) of FIG. 26, metal OB1 is deposited on the surface of first electrode group 110 and at a place where each of the plurality of insulating films 170a, . . . , 170L is not disposed, to form a metal thin film. As a result, it is possible to prevent the concentration of the electric field in first electrode group 110 corresponding to the edge in the width direction of each of the plurality of second electrodes 210a, . . . , 210N disposed to face first electrode group 110.

Note that a number of first electrodes constituting first electrode group 110 and a number of second electrodes constituting second electrode group 210 according to the first exemplary embodiment may not be the same.

The widths of the respective electrodes of the plurality of first electrodes 110a, . . . , 110N and the respective electrodes of the plurality of second electrodes 210a, . . . , 210N may not be the same.

EC element 100 according to the first exemplary embodiment has been described as assumed to perform passive-matrix driving, but the EC element is not limited to EC element 100 that performs passive-matrix driving. For example, EC element 100 may be configured by first electrode 110a and second electrode 210a and may be driven by an active matrix.

EC element 100 according to the first exemplary embodiment is not limited to EC element 100 to which only each configuration example has been applied alone but may be EC element 100 to which a plurality of configuration examples is applied.

In addition, one of first electrode group 110 and second electrode group 210 may be an electrode having no translucency or may not be a transparent electrode depending on the application of EC element 100 and light control device 1000. Further, each configuration example according to the first exemplary embodiment may be applied to only one of first electrode group 110 and second electrode group 210 in EC element 100. Thus, the manufacturing cost of EC element 100 is reduced, and EC element 100 according to the desired use of the user can be provided.

As described above, EC element 100 according to the first exemplary embodiment includes the plurality of rectangular first electrodes 110a, . . . , 110N having translucency and arranged in parallel, the plurality of rectangular second electrodes 210a, . . . , 210N arranged in parallel to face the plurality of first electrodes 110a, . . . , 110N, and electrolytic solution EL1 containing metal OB1 disposed between the plurality of first electrodes 110a, . . . , 110N and the plurality of second electrodes 210a, . . . , 210N. In electrolytic solution EL1, metal OB1 can be deposited on any one of the plurality of first electrodes 110a, . . . , 110N and the plurality of second electrodes 210a, . . . , 210N in accordance with the applied voltage, and at least one of first electrodes 110a, . . . , 110N and second electrodes 210a, . . . , 210N has an electrode resistance value higher than the central position in the width direction at the end in the width direction.

Thereby, EC element 100 can suppress the electric field at the edge in the width direction of the electrode at the time of driving and reduce the display unevenness to achieve the high-quality display.

At least one of first electrodes 110a, . . . , 110N and second electrodes 210a, . . . , 210N has different resistance values in at least three stages from the central position toward the end. Thereby, EC element 100 can suppress the electric field at the edge in the width direction of the electrode at the time of driving and reduce the display unevenness to achieve the high-quality display.

At least one of first electrodes 110a, . . . , 110N and second electrodes 210a, . . . , 210N is formed to include high-resistance electrode member HR and a plurality of low-resistance electrode members LR having different sizes in accordance with positions in the width direction. Thereby, EC element 100 can suppress the electric field at the edge in the width direction of the electrode at the time of driving and reduce the display unevenness to achieve the high-quality display.

At least one of first electrodes 110a, . . . , 110N and second electrodes 210a, . . . , 210N is formed to include high-resistance electrode member HR and a plurality of low-resistance electrode members LR having different arrangement densities in accordance with positions in the width direction. Thereby, EC element 100 can suppress the electric field at the edge in the width direction of the electrode at the time of driving and reduce the display unevenness to achieve the high-quality display.

Each of first electrodes 110a, . . . , 110N and second electrodes 210a, . . . , 210N has the lowest resistance value at the central position in the width direction and has a resistance value relatively higher than that at the central position at the end in the width direction. Thereby, EC element 100 can suppress the electric field at the edge in the width direction of the electrode at the time of driving and reduce the display unevenness to achieve the high-quality display.

In addition, EC element 100 further includes non-display electrode group 150, as an example of the first non-display electrode on which metal OB1 is not deposited at the time of voltage application, adjacent to at least one of the plurality of first electrodes 110a, . . . , 110N. EC element 100 further includes non-display electrode group 250, as an example of the second non-display electrode on which metal OB1 is not deposited at the time of voltage application, adjacent to at least one of the plurality of second electrodes 210a, . . . , 210N. Thereby, EC element 100 can prevent the concentration of the electric field on the edge between spacer 300 and the outermost periphery of each of first electrode group 110 and second electrode group 210. Therefore, EC element 100 can reduce display unevenness that occurs at the edge in the width direction of the electrode and the outermost periphery of the electrode at the time of driving to achieve the high-quality display.

First electrodes 110a, . . . , 110N and second electrodes 210a, . . . , 210N respectively have a plurality of notches 160a, . . . , 160M and a plurality of notches 260a, . . . , 260M along the respective longitudinal directions. The plurality of notches 160a, . . . , 160M and the plurality of notches 260a, . . . , 260M are notched in the width direction orthogonal to the longitudinal direction. Thus, EC element 100 can form a plurality of corners of each of a plurality of display pixels on which metal OB1 is deposited in a round shape. Therefore, EC element 100 can reduce the display unevenness that occurs at the corner of the display pixel at the time of driving to achieve the high-quality display.

EC element 100 further includes a plurality of insulating films 170a, . . . , 170L. Each of the plurality of second electrodes 210a, . . . , 210N is disposed with a predetermined gap from an adjacent second electrode. Each of the plurality of insulating films 170a, . . . , 170L is disposed so as to straddle a predetermined gap. Thereby, EC element 100 can prevent the concentration of the electric field on the gap portion between the second electrodes adjacent to each other. Therefore, EC element 100 can reduce the display unevenness that occurs at the edge of the gap of second electrode group 210 at the time of driving to achieve the high-quality display.

In addition, the plurality of insulating films 170a, . . . , 170L are provided on surfaces of the plurality of first electrodes 110a, . . . , 110N facing the plurality of second electrodes 210a, . . . , 210N. As a result, EC element 100 can reduce the display unevenness that occurs at the edge of the gap of second electrode group 210 at the time of driving to achieve the high-quality display.

Although various exemplary embodiments have been described above with reference to the accompanying drawings, the present disclosure is not limited to such examples. It is obvious that those skilled in the art can conceive various changes, modifications, substitutions, additions, deletions, and equivalents within the scope described in the claims, and it is understood that these also belong to the technical scope of the present disclosure. In addition, the respective constituent elements in the various exemplary embodiments described above may be arbitrarily combined without departing from the gist of the invention.

The present disclosure is useful as a light control element that suppresses an electric field of an edge in a width direction of an electrode at the time of driving an electrochromic (EC) element and reduces display unevenness to achieve high-quality display.

What is claimed is:

1. The light control element includes;
a plurality of first electrodes having translucency and arranged in parallel to each other, each of the plurality of first electrodes being rectangular and a first electrode;
a plurality of second electrodes arranged in parallel to each other and facing the plurality of first electrodes, each of the plurality of second electrodes each being rectangular and a second electrode; and
an electrolytic solution containing metal and disposed between the plurality of first electrodes and the plurality of second electrodes,
wherein the electrolytic solution deposits the metal on any one of the plurality of first electrodes and the plurality of second electrodes in accordance with an applied voltage, and
at least one of the first electrode and the second electrode has a resistance value higher at an end in a width direction than at a central position in the width direction.

2. The light control element according to claim 1, wherein at least one of the first electrode and the second electrode has different resistance values in at least three stages from the central position toward the end.

3. The light control element according to claim 1, wherein at least one of the first electrode and the second electrode is formed to include a high-resistance electrode member and a plurality of low-resistance electrode members having different sizes in accordance with positions in the width direction.

4. The light control element according to claim 1, wherein at least one of the first electrode and the second electrode is formed to include a high-resistance electrode member and a plurality of low-resistance electrode members having different arrangement densities in accordance with positions in the width direction.

5. The light control element according to claim 1, wherein each of the first electrode and the second electrode has a resistance value lowest at the central position in the width direction and relatively higher at the end in the width direction than at the central position.

6. The light control element according to claim 1, further comprising:
a first non-display electrode that is adjacent to at least one of the plurality of first electrodes and on which the metal is not deposited when a voltage is applied; and
a second non-display electrode that is adjacent to at least one of the plurality of second electrodes and on which the metal is not deposited when a voltage is applied.

7. The light control element according to claim 1, wherein
the first electrode and the second electrode each have a plurality of notches along respective longitudinal directions of the first electrode and the second electrode, and
each of the plurality of notches is formed in the width direction orthogonal to a corresponding one of the longitudinal directions.

8. The light control element according to claim 1, further comprising a plurality of insulating films,
wherein the second electrode is disposed with a predetermined gap between one the plurality of second electrodes and the second electrode adjacent to the one the plurality of second electrodes, and
each of the plurality of insulating films is disposed so as to straddle the predetermined gap.

9. The light control element according to claim 8, wherein the plurality of insulating films are provided on surfaces of the plurality of first electrodes facing the plurality of second electrodes.
